(19) United States
(12) Patent Application Publication
(10) Pub. No.: US 2025/0243835 A1
(43) Pub. Date: Jul. 31, 2025

(54) LOW PRESSURE PUMP FOR FUEL SYSTEM AND PRIMING CHECK VALVE FOR THE SAME

(71) Applicant: Cummins Inc., Columbus, IN (US)

(72) Inventors: Roberto Medina Munoz, Columbus, IN (US); Jayamuthu Kailash Karthikeyan, Columbus, IN (US)

(21) Appl. No.: 19/019,917

(22) Filed: Jan. 14, 2025

Related U.S. Application Data
(60) Provisional application No. 63/625,559, filed on Jan. 26, 2024.

(51) Int. Cl. F02M 59/46; F02M 37/04; F02M 51/04

(52) U.S. Cl. CPC F02M 59/46; F02M 51/04; F02M 37/041

(57) ABSTRACT

A fuel system for an internal combustion engine includes a low pressure pump with a priming check valve. The priming check valve extends into the outlet flow path at a junction of the outlet flow path and a priming flow path that connects an inlet flow path of the low pressure pump to the outlet flow path.

### CROSS-REFERENCE TO RELATED APPLICATION

The present application claims the benefit of the filing date of U.S. Provisional App. Ser. No. 63/625,559 filed on Jan. 26, 2024, which is incorporated herein by reference.

### FIELD OF THE DISCLOSURE

The present disclosure relates generally to fuel systems for internal combustion engines, and more particularly, but not exclusively, to a priming check valve for a low pressure pump of the fuel system.

### BACKGROUND

Common rail direct fuel injection is commonly used on fueling systems for internal combustion engines, such as diesel engines. The common rail direct fuel system typically includes a low pressure pump operatively connected and attached to a high pressure pump. The low pressure pump directs fuel to the high pressure pump, which thereafter increases the fuel pressure to satisfy fueling pressure requirements. The pressurized fuel from the high pressure pump is sent to a rail that balances out the pressure per the number of connected fuel injectors, which spray the fuel into the engine.

In response to a key-on event, the fuel system can be primed by operation of an electric lift pump at or near the fuel tank. The low pressure pump includes a priming pathway with a check valve that opens to allow priming of the fuel system, and the check valve closes once the electric lift pump is shut off. After priming, the low pressure pump includes internal gears that are driven by operation of the engine to direct pressurized fuel to the high pressure pump.

Pressure pulsations are created downstream of the low pressure pump due to the low pressure pump design, fuel system plumbing configuration, downstream fuel system restrictions, and/or pump speed. To limit the outlet pressure, the low pressure pump typically includes a pressure regulator valve on the outlet side of the low pressure pump. However, the flow and pressure fluctuations that are allowed create durability concerns for internal components of the low pressure pump, such as the priming check valve. As such, there exists a need for improvements in low pressure pumps for fuel systems of internal combustion engines.

### SUMMARY

The present disclosure includes a low pressure pump that pumps fuel for a fuel system with a priming check valve located between the inlet and the outlet of the low pressure pump. The priming check valve is operable to regulate the flow of fuel from a fuel source from the inlet of the low pressure pump to the outlet of the low pressure pump during priming of the fuel system downstream of the low pressure pump.

In an embodiment of the present disclosure, a fuel system for an internal combustion engine is provided. The fuel system includes a fuel pump having an inlet flow path for receiving fuel from a fuel source. The fuel pump has an outlet flow path for outletting pressurized fuel. The fuel pump includes a priming flow path that extends from the inlet flow path to the outlet flow path, and the priming flow path includes a priming seat. A pumping flow path is connected to the inlet flow path downstream of the priming flow path, and connected to the outlet flow path upstream of the priming flow path. The fuel system also includes a priming check valve connecting the priming flow path to the outlet flow path. The priming check valve includes a valve member and a valve seat in the outlet flow path. The valve member engages the priming seat in the priming flow path to close the priming flow path. The valve member engages the valve seat located in the outlet flow path to open the priming flow path.

In an embodiment of the present disclosure, a priming check valve for a low pressure pump of a fuel system is provided. The priming check valve includes a base configured to be engaged to a housing of the low pressure pump, an elongated shaft extending from the base, and a seat at an outer end of the shaft. The priming check valve also includes a spring around the shaft and a valve member supported on the spring. The spring biases the valve member away from the seat to a first position, and the spring compresses as the valve member is displaced to engage the seat. The shaft supports a majority of a length of the spring in the first position.

In an embodiment of the present disclosure, a low pressure pump includes a housing and a priming check valve engaged to the housing. The housing includes an inlet flow path for receiving fuel from a fuel source, and an outlet flow path for outletting pressurized fuel. The housing also includes a priming flow path extending from the inlet flow path to the outlet flow path. The priming flow path including a priming path seat. The housing further includes a pumping flow path connected to the inlet flow path downstream of the priming flow path. The pumping flow path is further connected to the outlet flow path upstream of the priming flow path. The priming check valve includes a shaft extending into the outlet flow path to a valve seat in the outlet flow path, a spring around the shaft, and a valve member supported by the spring. The spring biases the valve member into engagement with the priming path seat to close the priming flow path, and the valve member is displaced to compress the spring and engage the valve seat in the outlet flow path to open the priming flow path.

This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The description herein makes reference to the accompanying drawings wherein like numerals refer to like parts throughout the several views, and wherein:

FIG. 1 is a schematic block diagram of an example fuel system for an internal combustion engine according to an embodiment of the present disclosure.

FIG. 2 is an elevation view of a low pressure pump of the fuel system of FIG. 1 according to an embodiment of the present disclosure.

FIG. 3 is a section view of the low pressure pump of FIG. 2 showing a priming check valve according an embodiment of the present disclosure.

FIG. 4 is a section view of the low pressure pump of FIG. 2 with the priming check valve in a closed position.

FIG. 5 is a section view of the low pressure pump of FIG. 2 with the priming check valve in a closed position.

FIG. 6 is a section view of the priming check valve in the closed position in the housing of the low pressure pump.

### DETAILED DESCRIPTION OF ILLUSTRATIVE EMBODIMENTS

For the purposes of clearly, concisely and exactly describing illustrative embodiments of the present disclosure, the manner and process of making and using the same, and to enable the practice, making and use of the same, reference will now be made to certain exemplary embodiments, including those illustrated in the figures, and specific language will be used to describe the same. It shall nevertheless be understood that no limitation of the scope of the invention is thereby created, and that the invention includes and protects such alterations, modifications, and further applications of the exemplary embodiments as would occur to one skilled in the art.

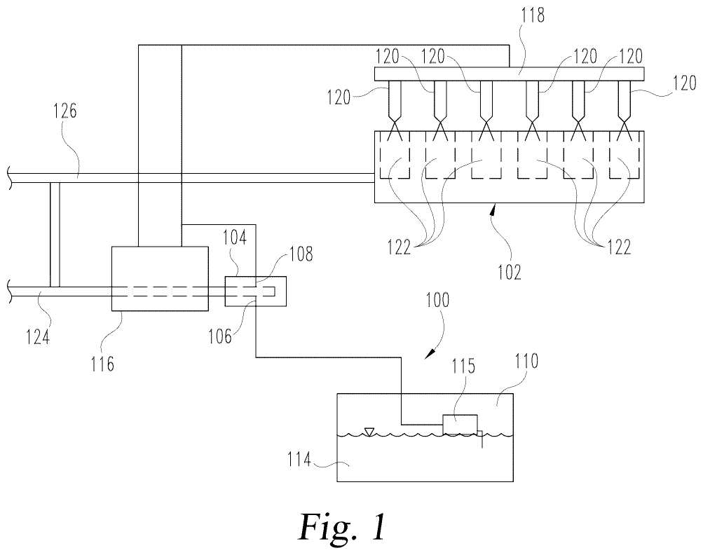

Referring to FIGS. 1-5, a fuel system 100 for an internal combustion engine 102 is illustrated. In an embodiment of the present disclosure, fuel system 100 includes a low pressure pump 104 having an inlet flow path 106 for receiving fuel from a fuel source 110. Fuel pump 104 has an outlet flow path 108 for outletting pressurized fuel to fuel system 100. Low pressure pump 104 includes a priming flow path 112 extending from inlet flow path 106 to outlet flow path 108. Priming flow path 112 includes a priming path seat 146. Fuel system 100 includes a pumping flow path 148 connected to inlet flow path 106 downstream of priming flow path 112. Pumping flow path 148 is further connected to outlet flow path 108 upstream of priming flow path 112. A priming check valve 130 connects priming flow path 112 to outlet flow path 108. Priming check valve 130 includes a valve member 140 and a valve seat 138 in outlet flow path 108. Valve member 140 engages priming path seat 146 to close priming flow path 112 and is displaced into engagement with the valve seat 138 in outlet flow path 108 to open priming flow path 112.

In an embodiment of the present disclosure, priming check valve 130 is provided for low pressure pump 104 of fuel system 100. Priming check valve 130 includes a base 132 engageable to low pressure pump 104 and an elongated shaft 134 extending from the base 132. Elongated shaft 134 includes valve seat 138 at an end 144 of shaft 134 opposite base 132. A spring 142 positioned around shaft 134, and valve member 140 is supported by spring 142. Spring 142 biases valve member 140 away from valve seat 138 to a first position, and spring 142 compresses as valve member 140 is moved toward engagement with valve seat 138. Shaft 134 supports a majority of a length of spring 142 in the first position.

In an embodiment of the present disclosure, low pressure pump 104 is provided for fuel system 100 of internal combustion engine 102. Low pressure pump 104 includes a housing 180 and priming check valve 130 engaged to housing 180. Housing 180 includes inlet flow path 106 for receiving fuel from fuel source 110, and outlet flow path 108 for outletting pressurized fuel. Housing 180 also includes priming flow path 112 extending from inlet flow path 106 to outlet flow path 108. Priming flow path 112 includes priming path seat 146. Housing 180 further includes pumping flow path 148 connected to inlet flow path 106 downstream of priming flow path 112. Pumping flow path 148 is further connected to outlet flow path 108 upstream of priming flow path 112. Priming check valve130 includes shaft134 extending into outlet flow path 108 to valve seat 138 in outlet flow path 108. Spring 142 is around shaft 134, and valve member 140 is supported by spring 142. Spring 142 biases valve member 140 into engagement with priming path seat 146 to close priming flow path 112, and valve member 140 is displaced to compress spring 142 and engage valve seat 138 in outlet flow path 108 to open priming flow path 112.

Fuel system 100 in FIG. 1 is configured to provide fuel 114 from fuel source 110 to internal combustion engine 102. Fuel source 110 can be, for example, a fuel tank. In an embodiment, fuel source 110 includes an electric lift pump 115 to prime fuel system 100, as discussed further below. Fuel system 100 includes a lower pressure or low pressure pump 104 that pressurizes and provides fuel to an inlet of a downstream of a higher pressure or high pressure pump 116. Low pressure pump 104 is upstream of high pressure pump 116. A camshaft 124 can be provided to mechanically drive each of low pressure pump 104 and high pressure pump 116. Camshaft 124 can be connected to and driven by an output shaft 126 of engine 102.

High pressure pump 116 further pressurizes the fuel and provides it to fuel rail 118, which distributes the pressurized fuel to a plurality of fuel injectors 120. Engine 102 includes cylinders 122 that each receive fuel from one or more of the fuel injectors 120 connected to rail 118. It should be understood that only some components of fuel system 100 are shown in FIG. 1. Other details and components, such as priming pumps, filters, valves, drains, bypasses, plumbing, venturi devices, etc. are omitted for clarity and/or not being relevant to the present disclosure.

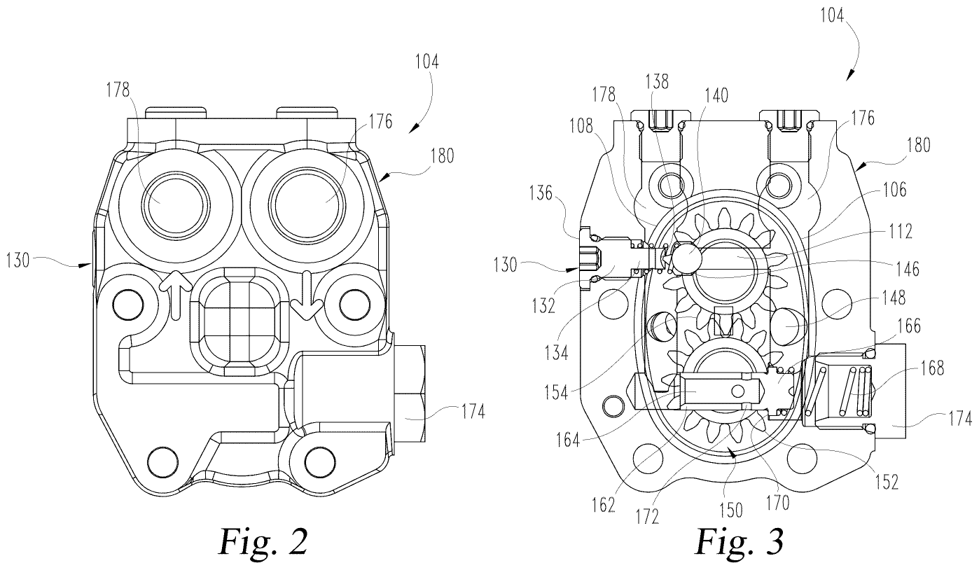

Referring further to FIGS. 2-5, low pressure pump 104 includes a pump housing 180 with an inlet 176 connected to inlet flow path 106 and an outlet 178 connected to outlet flow path 108. Inlet 176 of low pressure pump 104 receives fuel from the fuel source 110. The fuel flows through inlet flow path 106, is pressurized by low pressure pump 104, and provided to outlet flow path 108 where it passes through outlet 178 and is provided to the inlet of high pressure pump 116. The flow of fuel through inlet flow path 106 is controlled either by the electric lift pump 115 operating to provide fuel to low pressure pump 104, or by suction created by gear assembly 150 in low pressure pump 104.

Priming flow path 112 extends between and fluidly connects inlet flow path 106 to outlet flow path 108. Priming check valve 130 is provided at the junction between priming flow path 112 and outlet flow path 108. Priming check valve 130 includes valve member 140 biased by spring 142 into engagement with priming path seat 146. In the illustrated embodiment, priming path seat 146 includes a tapered, frusto-conical shape configured to receive valve member 140 in a manner that sufficiently closes priming flow path 112 during non-priming modes of operation.

During operation of electric lift pump 115, such as during a key on event, the fuel pressure created by electric lift pump 115 is sufficient to unseat valve member 140 from priming path seat 146. Valve member 140 can be moved into outlet flow path 108 until it engages valve seat 138, opening priming flow path 112 to allow priming of fuel system 100 downstream of low pressure pump 104. In the engaged position with valve seat 138, valve member 140 can extend between outlet flow path 108 and priming flow path 112 such that valve member 140 cannot be dislodged completely into outlet flow path 108.

Low pressure pump also includes pumping flow path 148 connected to inlet flow path 106 downstream of priming flow path 112. Pumping flow path 148 is further connected to outlet flow path 108 upstream of priming flow path 112. Gear assembly 150 is located in pumping flow path 148. Gear assembly 150 is driven by cam shaft 124 to pump fluid from inlet flow path 106 to outlet flow path 108.

In an embodiment, gear assembly 150 includes a first gear 152 and a second gear 154 meshed with first gear 150. In an embodiment, one of gears 152, 154 is a driven gear and the other gear is an idler gear. In the illustrated embodiment, gear assembly is an external gear assembly. However, other types of gear assemblies are also contemplated, including internal gear assemblies.

Low pressure pump 104 further includes a pressure relieve valve 160 fluidly connected to outlet flow path 108. Pressure relief valve 160 includes an elongated valve member 162 with a channel 164 to receive fluid from outlet flow path 108. Valve member 162 includes a head 166 that is biased into engagement with inlet flow path seat 170 by a spring 168. Spring 168 extends between relief valve port plug 174 and an annular flange protruding radially outwardly from head 166. When fluid pressure in outlet flow path 108 exceeds a pressure that is sufficient to displace valve member 162 against spring 168, valve member 162 moves to align pressure relief outlet 172 with inlet flow path 106.

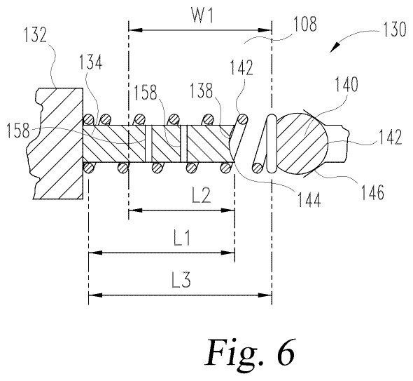

Referring further to FIG. 6, additional details relating to priming check valve 130 are shown. Priming check valve 130 can be located at the junction of the outlet flow path 108 and priming flow path 112 of low pressure pump 104. In an embodiment, priming check valve 130 is located at the downstream end of priming flow path 112 and upstream of outlet 178 on pump housing 180 of low pressure pump 104. In an embodiment, priming check valve 130 is mounted on housing 180 of low pressure pump 104 and extends into outlet flow path 108.

Priming check valve 130 includes base 132 engaged to housing 180 of low pressure pump 104. A head 136 extends outwardly from one side of base 132. Head 136 can includes a driving tool recess to facilitate installation and removal of priming check valve 130 from housing 180. Shaft 134 extends from base 132 in a direction opposite head 136. Head 136 projects radially outwardly from base 132, and base 132 projects radially outwardly from shaft 134

Shaft 134 extends from base 132 to an end 144 of shaft 134. End 134 includes valve seat 138. In an embodiment, valve seat 138 is a concave recess in end 134. In an embodiment, the concave recess is spherically shaped to complement that spherical shape of ball type valve member 140. Other embodiments contemplate other shapes for valve seat 138 and/or valve member 140. For example, disc-shaped, cylindrically-shaped, or flat-shaped valve seats and/or valve members are also contemplated.

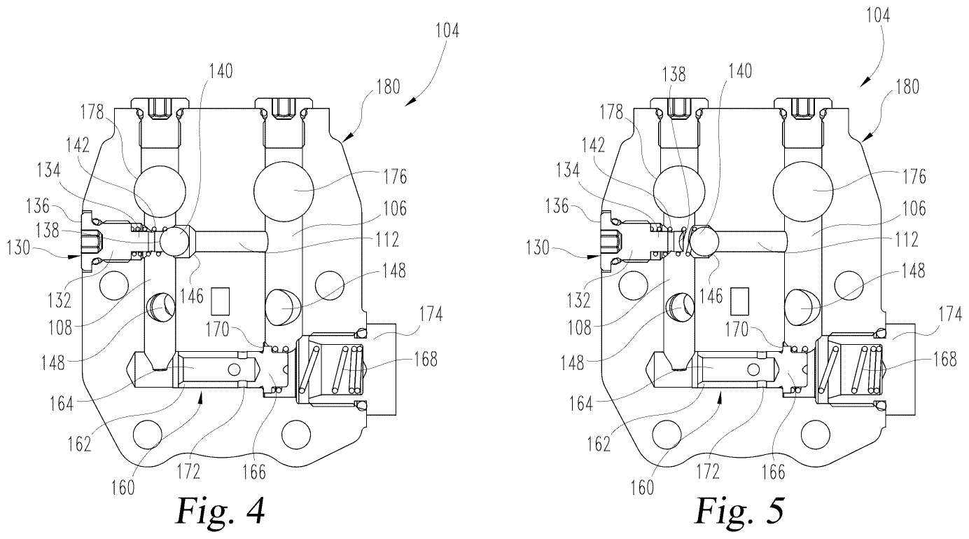

In an embodiment, outlet flow path 108 includes a cross-sectional dimension W1 that extends transversely to the fluid flow through outlet flow path 108. Shaft 134 includes a length L1 from base 132 to end 144 configured so shaft 134 has a length L2 projecting into outlet flow path 108. In an embodiment, length L2 is at least one-third of cross-sectional dimension WI so that the travel distance of valve member 140 is minimized while moving from the closed position of FIG. 5 against priming path seat 146 to the open position of FIG. 4 in engagement with valve seat 138. In an embodiment, length L2 is more at least one half of cross-sectional dimension WI so that the travel distance of valve member 140 from priming path seat 146 to valve seat 138 is minimized.

Spring 142 has a length L3 from base 132 to valve member 140 that biases valve member 140 into contact with priming path seat 146 in a closed position, as shown in FIGS. 5-6. Length L1 of shaft 134 supports over one half of length L3 of spring 142 to provide stability for spring 142 during pressure fluctuations in outlet flow path. Due to the intrusion of shaft 134 into outlet flow path 108, shaft 134 can include one or more bores 158 that extend transversely to the length of shaft 134 and in the direction of outlet flow path 108 to allow for fuel flow through shaft 134.

Priming check valve 130 reduces the allowable displacement of valve member 140 between priming path seat 146 and valve seat 138. Shaft 134 of priming check valve 130 extends into outlet flow path 108 to guide spring 142, which retains the valve member 140. The size and mass of valve member 140 will determine the flow and opening pressure required for a given design for the fuel system 100. Priming check valve 130 allows high flow/pressure fluctuations at the junction of outlet flow path and priming flow path 112 without compromising durability due to, for example, undesired movement between spring 142 and valve member 140 due to insufficient pressure to seat the valve member 140, spring special material or coating, particle obstruction, etc. Priming check valve 130 simplifies spring 142 by limiting its function to retain the valve member 142 against priming path seat 146.

During a priming cycle with electric lift pump 115, gear assembly 150 does not rotate. Electric lift pump 115 operates for a predetermined time period and primes the entire fuel circuit of fuel system 100. Since the gear assembly 150 is not turning, priming check valve 130 unscats from priming path seat 146 in order for the fuel flow from electric lift pump 115 to go past low pressure pump 104. The unseating of priming check valve 130 allows the fuel flow to bypass the more restrictive pumping flow path 148 that includes gear assembly 150. The travel of valve member 140 to valve seat 138 is restricted by the length of shaft 134, as discussed above, such that valve member 140 cannot fall off spring 142 into outlet flow path 108. For example, as shown in FIG. 4, valve member 140 is at least partially retained in priming flow path 112 even in the open position. The length of shaft 134 also supports and guides a majority of the length of spring 142, resisting buckling of spring 142 and allowing low stiffness springs to be used.

When gear assembly 150 of low pressure pump 104 starts to rotate, electric lift pump 115 is switched off and low pressure pump 104 starts to transfer fuel from fuel source 114 to high pressure pump 116. The inlet pressure of low pressure pump 104 will become a vacuum, and valve member 140 seats against priming path seat 146 because of the vacuum at inlet flow path 106 and the pressure at outlet flow path 108. The fuel flow now goes through the pumping flow path 148 and gear assembly 150 to outlet flow path 108. The shaft 134 extends into outlet flow path 108, as discussed above, partially restricts the fuel flow coming out of the gear assembly 150. One or more bores 158 in shaft 134 create a flow path for the fuel, thus reducing the flow restriction cause by shaft 134. In addition, shaft 134 supports a majority of the length of spring 142 to protect spring 142 from the pulsating flow caused by the gear meshing of gear assembly 150.

Further written description of a number of example aspects of the present disclosure and embodiments thereof shall now be provided. It should be appreciated that any combination of one or more of the embodiments is contemplated.

According to one aspect of the present disclosure, a fuel system for an internal combustion engine is provided. The fuel system includes a low pressure pump having an inlet flow path for receiving fuel from a fuel source and an outlet flow path for outletting pressurized fuel. The low pressure pump includes a priming flow path extending from the inlet flow path to the outlet flow path, and the priming flow path includes a priming path seat. The low pressure pump also includes a pumping flow path connected to the inlet flow path downstream of the priming flow path. The pumping flow path is further connected to the outlet flow path upstream of the priming flow path. The low pressure pump also includes a priming check valve connecting the priming flow path to the outlet flow path. The priming check valve includes a valve member and a valve seat in the outlet flow path. The valve member engages the priming path seat to close the priming flow path and is displaced into engagement with the valve seat in the outlet flow path to open the priming flow path.

In an embodiment, the fuel system includes a high pressure pump downstream of the low pressure pump, and a fuel tank upstream of the low pressure pump.

In a further embodiment, the fuel system includes an electric lift pump in the fuel tank. The electric lift pump is operable to provide pressurized fuel to the low pressure pump to displace the valve member from the priming seat to the valve seat during priming of the fuel system.

In an embodiment, the low pressure pump includes a gear assembly in the pumping flow path. The gear assembly is driven by a camshaft to pump fluid from the inlet flow path to the outlet flow path, and the camshaft is driven by an output shaft of the internal combustion engine.

In a further embodiment, the gear assembly includes a first gear and a second gear meshed with the first gear.

In an embodiment, the priming check valve includes a base engaged to the low pressure pump and a shaft extending from the base into the outlet flow path. The valve seat is located on an end of the shaft. A spring is around the shaft and the spring is engaged to the valve member to bias the valve member toward the priming path seat.

In a further embodiment, the outlet flow path includes a cross-sectional width, and the shaft extends across at least one third of the cross-sectional width of the outlet flow path.

In yet a further embodiment, the shaft extends across at least half of the cross-sectional width of the outlet flow path.

In a further embodiment, the valve member is a ball valve, and the valve seat is a concave depression in the end of the shaft.

In a further embodiment, the spring extends from the base through the outlet flow path to bias the valve member against the priming path seat.

In yet a further embodiment, the shaft is located in and supports the spring in the outlet flow path.

In a further embodiment, the shaft includes at least one bore that extends transversely through the shaft to facilitate fuel flow in the outlet flow path through the shaft.

In an embodiment, the low pressure pump includes pressure relief valve in fluid communication with the outlet flow path. The pressure relief valve is configured to open to fluidly connect the outlet flow path to the inlet flow path in response a fluid pressure in the outlet flow path exceeding a pressure threshold.

In another aspect of the present disclosure, a priming check valve for a low pressure pump is provided. The priming check valve includes a base engageable to the low pressure pump and an elongated shaft extending from the base. The elongated shaft includes a valve seat at an end of the shaft opposite the base. The priming check valve also includes a spring positioned around the shaft and a valve member supported by the spring. The spring biases the valve member away from the valve seat to a first position, and the spring compresses as the valve member is moved toward engagement with the valve seat. The shaft supports a majority of a length of the spring in the first position.

In an embodiment, the valve seat is a concave depression in the end of the shaft.

In an embodiment, the valve member is a ball valve that is received in the concave depression when the valve member is engaged to the valve seat.

In an embodiment, the shaft includes a length extending from the base to the end of the shaft. The shaft includes at least one bore that extends through the shaft transversely to the length.

In a further embodiment, the shaft includes a plurality of bores extending therethrough transversely to the length of the shaft.

In an embodiment, the priming check valve includes a head extending from the base opposite the shaft. The base projects radially outwardly from the shaft, and the head projects radially outwardly from the base.

According to another aspect of the present disclosure, a low pressure pump for a fuel system of an internal combustion engine is provided. The low pressure pump includes a housing and a priming check valve engaged to the housing. The housing includes an inlet flow path for receiving fuel from a fuel source, and an outlet flow path for outletting pressurized fuel. The housing also includes a priming flow path extending from the inlet flow path to the outlet flow path. The priming flow path including a priming path seat. The housing further includes a pumping flow path connected to the inlet flow path downstream of the priming flow path. The pumping flow path is further connected to the outlet flow path upstream of the priming flow path. The priming check valve includes a shaft extending into the outlet flow path to a valve seat in the outlet flow path, a spring around the shaft, and a valve member supported by the spring. The spring biases the valve member into engagement with the priming path seat to close the priming flow path, and the valve member is displaced to compress the spring and engage the valve seat in the outlet flow path to open the priming flow path.

In an embodiment, in the open position, the valve partially resides in the outlet flow path and partially resides in the priming flow path while engaged to the valve seat.

While illustrative embodiments of the disclosure have been illustrated and described in detail in the drawings and foregoing description, the same is to be considered as illustrative and not restrictive in character, it being understood that only certain exemplary embodiments have been shown and described and that all changes and modifications that come within the spirit of the claimed inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A fuel system for an internal combustion engine, the fuel system comprising:
a low pressure pump having an inlet flow path for receiving fuel from a fuel source, the low pressure pump having an outlet flow path for outletting pressurized fuel, the low pressure pump including:
a priming flow path extending from the inlet flow path to the outlet flow path, the priming flow path including a priming path seat; and
a pumping flow path connected to the inlet flow path downstream of the priming flow path, the pumping flow path further connected to the outlet flow path upstream of the priming flow path; and
a priming check valve connecting the priming flow path to the outlet flow path, wherein the priming check valve includes a valve member and a valve seat in the outlet flow path, wherein the valve member engages the priming path seat to close the priming flow path and is displaced into engagement with the valve seat in the outlet flow path to open the priming flow path.

2. The fuel system of claim 1, further comprising:
a high pressure pump downstream of the low pressure pump; and
a fuel tank upstream of the low pressure pump.

3. The fuel system of claim 2, further comprising an electric lift pump in the fuel tank, wherein the electric lift pump is operable to provide pressurized fuel to the low pressure pump to displace the valve member from the priming seat to the valve seat during priming of the fuel system.

4. The fuel system of claim 1, wherein the low pressure pump includes a gear assembly in the pumping flow path, the gear assembly being driven by a cam shaft to pump fluid from the inlet flow path to the outlet flow path, and the cam shaft is driven by an output shaft of the internal combustion engine.

5. The fuel system of claim 4, wherein the gear assembly includes a first gear and a second gear meshed with the first gear.

6. The fuel system of claim 1, wherein the priming check valve includes:
a base engaged to the low pressure pump;
a shaft extending from the base into the outlet flow path, wherein the valve seat is located on an end of the shaft; and
a spring around the shaft, the spring being engaged to the valve member to bias the valve member toward the priming path seat.

7. The fuel system of claim 6, wherein the outlet flow path includes a cross-sectional width, and the shaft extends across at least one third of the cross-sectional width of the outlet flow path.

8. The fuel system of claim 7, wherein the shaft extends across at least half of the cross-sectional width of the outlet flow path.

9. The fuel system of claim 6, wherein the valve member is a ball valve, and the valve seat is a concave depression in the end of the shaft.

10. The fuel system of claim 6, wherein the spring extends from the base through the outlet flow path to bias the valve member against the priming path seat.

11. The fuel system of claim 10, wherein the shaft is located in and supports the spring in the outlet flow path.

12. The fuel system of claim 6, wherein the shaft includes at least one bore that extends transversely through the shaft to facilitate fuel flow in the outlet flow path through the shaft.

13. The fuel system of claim 1, wherein the low pressure pump includes pressure relief valve in fluid communication with the outlet flow path, the pressure relief valve being configured to open to fluidly connect the outlet flow path to the inlet flow path in response a fluid pressure in the outlet flow path exceeding a pressure threshold.

14. A priming check valve for a low pressure pump of a fuel system, the priming check valve comprising:
a base engageable to the low pressure pump;
an elongated shaft extending from the base, the elongated shaft including a valve seat at an end of the shaft opposite the base;
a spring positioned around the shaft; and
a valve member supported by the spring, the spring biasing valve member away from the valve seat to a first position, and the spring compresses as the valve member is moved toward engagement with the valve seat, wherein the shaft supports a majority of a length of the spring in the first position.

15. The priming check valve of claim 14, wherein:
the valve seat is a concave depression in the end of the shaft; and
the valve member is a ball valve that is received in the concave depression when the valve member is engaged to the valve seat.

16. The priming check valve of claim 14, wherein:
the shaft includes a length extending from the base to the end of the shaft; and
the shaft includes at least one bore that extends through the shaft transversely to the length.

17. The priming check valve of claim 16, wherein the shaft includes a plurality of bores extending therethrough transversely to the length of the shaft.

18. The priming check valve of claim 14, further comprising a head extending from the base opposite the shaft, and wherein the base projects radially outwardly from the shaft, and the head projects radially outwardly from the base.

19. A low pressure pump for a fuel system of an internal combustion engine, the low pressure pump comprising:
a housing including:
an inlet flow path for receiving fuel from a fuel source;
an outlet flow path for outletting pressurized fuel;
a priming flow path extending from the inlet flow path to the outlet flow path, the priming flow path including a priming path seat; and
a pumping flow path connected to the inlet flow path downstream of the priming flow path, the pumping flow path further connected to the outlet flow path upstream of the priming flow path;
a priming check valve engaged to the housing, the priming check valve including:
a shaft extending into the outlet flow path to a valve seat in the outlet flow path;
a spring around the shaft; and
a valve member supported by the spring, wherein the spring biases the valve member into engagement with the priming path seat to close the priming flow path, and the valve member is displaced to compress the spring and engage the valve seat in the outlet flow path to open the priming flow path.

20. The low pressure pump of claim 19, wherein the valve member partially resides in the outlet flow path and in the priming flow path while engaged to the valve seat.
